(19) United States
(12) Patent Application Publication
(10) Pub. No.: US 2026/0019236 A1
(43) Pub. Date: Jan. 15, 2026

(54) ELECTRONIC DEVICE FOR REGISTERING OR RECOVERING CREDENTIALS

(71) Applicant: SAMSUNG ELECTRONICS CO., LTD., Suwon-si (KR)

(72) Inventors: Dongmin KIM, Suwon-si (KR); Bumhan KIM, Suwon-si (KR); Hyewon PARK, Suwon-si (KR); Jungha PAIK, Suwon-si (KR); Dongwook SHIM, Suwon-si (KR)

(73) Assignee: SAMSUNG ELECTRONICS CO., LTD., Suwon-si (KR)

(21) Appl. No.: 19/262,838

(22) Filed: Jul. 8, 2025

Related U.S. Application Data
(63) Continuation of application No. PCT/KR2025/007262, filed on May 28, 2025.

(30) Foreign Application Priority Data
Jul. 10, 2024 (KR) 10-2024-0091366
Aug. 22, 2024 (KR) 10-2024-0112893

(51) Int. Cl. H04L 9/08

(52) U.S. Cl. CPC H04L 9/0822; H04L 9/0894

(57) ABSTRACT

An electronic device obtains lock release information of the electronic device from a user, generates authentication information and a wrapping key based on the lock release information, generates a protection key and a recovery key to encrypt and decrypt the authentication information and credentials stored in the electronic device, encrypts the authentication information, the credentials, and the protection key based on keys of the electronic device including the protection key and the recovery key, and transmits the encrypted credentials, the encrypted authentication information, and the encrypted protection key to a server performing a secure remote password (SRP) protocol with the electronic device.

### CROSS-REFERENCE TO RELATED APPLICATIONS

This application is a continuation application of International Application No. PCT/KR2025/007262 designating the United States, filed on May 28, 2025, in the Korean Intellectual Property Receiving Office and claiming priority to Korean Patent Application No. 10-2024-0091366, filed on Jul. 10, 2024, and Korean Patent Application No. 10-2024-0112893, filed on Aug. 22, 2024, in the Korean Intellectual Property Office, the disclosures of which are incorporated by reference herein in their entireties.

### BACKGROUND

### 1. Field

The disclosure relates to an electronic device for registering or recovering credentials.

### 2. Description of Related Art

Various cryptographic algorithms such as symmetric key encryption, public key encryption, electronic signatures, and hash algorithms may be used in order to use safe security services on an electronic device. Cryptographic algorithms may use cryptographic keys, and the security of security services may ultimately depend on the cryptographic keys. Therefore, it may be very important not to expose the cryptographic keys.

In a related art, a secure remote password (SRP) protocol, which is a password- based authenticated key exchange (PAKE) protocol, is used, in which a user registers their password in a server, and then verifies that the user is a legitimate user without exposing the password to the server and shares the session key between the user and the server.

The SRP protocol may be a two-way protocol that operates between a user and a server. The SRP protocol may include a registration process and a login process. In the registration process, a user may register information related to their password in the server. In the login process, the user may verify their identity without exposing their registered password. When the user is a legitimate user, the user and the server may share the same session key generated based on the password.

The above description has been possessed or acquired by the inventor(s) in the course of conceiving the present disclosure and is not necessarily publicly known before the present application is filed.

### SUMMARY

According to an aspect of the disclosure, an electronic device may include a memory configured to store instructions. The electronic device may include at least one processor. Wherein the instructions, when executed by the at least one processor individually or collectively, cause the electronic device to obtain lock release information of the electronic device from a user. Wherein the instructions, when executed by the at least one processor individually or collectively, cause the electronic device to generate authentication information and a wrapping key based on the lock release information. Wherein the instructions, when executed by the at least one processor individually or collectively, cause the electronic device to generate a protection key and a recovery key to encrypt and decrypt the authentication information and credentials stored in the electronic device. Wherein the instructions, when executed by the at least one processor individually or collectively, cause the electronic device to encrypt the authentication information, the credentials, and the protection key based on keys of the electronic device including the protection key and the recovery key. Wherein the instructions, when executed by the at least one processor individually or collectively, cause the electronic device to transmit the encrypted credentials, the encrypted authentication information, and the encrypted protection key to a server performing a secure remote password (SRP) protocol with the electronic device.

The instructions, when executed by the at least one processor individually or collectively, may cause the electronic device to generate the encrypted credentials by encrypting the credentials with the protection key. Wherein the instructions, when executed by the at least one processor individually or collectively, cause the electronic device to generate the encrypted protection key by encrypting a multi-encrypted protection key and the recovery key based on a public key of a security device communicating with the server. Wherein the instructions, when executed by the at least one processor individually or collectively, cause the electronic device to generate the encrypted authentication information by encrypting the authentication information with the recovery key.

The instructions, when executed by the at least one processor individually or collectively, may cause the electronic device to encrypt the protection key with the recovery key. Wherein the instructions, when executed by the at least one processor individually or collectively, cause the electronic device to generate the multi-encrypted protection key by encrypting the protection key encrypted with the recovery key with the wrapping key.

The server may be configured to store the encrypted credentials. The server may be configured to transmit the encrypted protection key and the encrypted authentication information to the security device communicating with the server to re-encrypt the encrypted protection key and the encrypted authentication information.

The security device may be configured to obtain the multi-encrypted protection key and the recovery key by decrypting the encrypted protection key with a private key of the security device. The security device may be configured to generate a first re-encrypted protection key by re-encrypting the recovery key and the multi-encrypted protection key with a symmetric key of the security device. The security device may be configured to transmit the first re-encrypted protection key to the server, wherein the server may be configured to store the first re-encrypted protection key.

Based on another electronic device of the user being identified as a device of the user based on the SRP protocol, the server may be configured to transmit the encrypted credentials to the another electronic device.

The server may be configured to store the encrypted credentials based on lock release information of the another electronic device used to determine whether the another electronic device is the device of the user.

The instructions, when executed by the at least one processor individually or collectively, may cause the electronic device to: based on obtaining a command to recover the credentials, perform the SRP protocol with the server to share a session key, wherein the command to recover the credentials may include the lock release information.

The instructions, when executed by the at least one processor individually or collectively, may cause the electronic device to obtain encrypted information from the server. Wherein the instructions, when executed by the at least one processor individually or collectively, cause the electronic device to decrypt the encrypted information based on the session key. Wherein the instructions, when executed by the at least one processor individually or collectively, cause the electronic device to recover the credentials based on the decrypted information based on the session key.

According to an aspect of the disclosure, an electronic device may include a memory configured to store instructions. The electronic device may include at least one processor. Wherein the instructions, when executed by the at least one processor individually or collectively, may cause the electronic device to based on obtaining lock release information used to store credentials from a user. Wherein the instructions, when executed by the at least one processor individually or collectively, may cause the electronic device to perform a secure remote password (SRP) protocol with a server communicating with the electronic device to share a session key with the server. Wherein the instructions, when executed by the at least one processor individually or collectively, may cause the electronic device to obtain, from the server, encrypted information in which encrypted credentials stored in the server and a second re-encrypted protection key are encrypted based on the session key. Wherein the instructions, when executed by the at least one processor individually or collectively, may cause the electronic device to obtain the encrypted credentials and the second re-encrypted protection key by decrypting the encrypted information with the session key. Wherein the instructions, when executed by the at least one processor individually or collectively, may cause the electronic device to generate a wrapping key based on the lock release information. Wherein the instructions, when executed by the at least one processor individually or collectively, may cause the electronic device to obtain the credentials by decrypting the second re-encrypted protection key and the encrypted credentials based on the wrapping key and keys stored in the electronic device.

The server may be configured to transmit a first re-encrypted protection key stored in the server to a security device. Wherein the security device may be configured to obtain a recovery key and a multi-encrypted protection key by decrypting the first re-encrypted protection key with a symmetric key of the security device. Wherein the security device may be configured to generate the second re-encrypted protection key by encrypting the recovery key and the multi-encrypted protection key with a public key of the electronic device.

The instructions, when executed by the at least one processor individually or collectively, may cause the electronic device to obtain the multi-encrypted protection key and the recovery key by decrypting the second re-encrypted protection key with a private key of the electronic device. Wherein the instructions, when executed by the at least one processor individually or collectively, may cause the electronic device to obtain a protection key by decrypting the multi-encrypted protection key with the wrapping key and the recovery key. Wherein the instructions, when executed by the at least one processor individually or collectively, may cause the electronic device to obtain the credentials by decrypting the encrypted credentials with the protection key.

According to an aspect of the disclosure, an operating method of an electronic device may include obtaining lock release information of the electronic device from a user; generating authentication information and a wrapping key based on the lock release information. The operating method of the electronic device may include generating a protection key and a recovery key to encrypt and decrypt the authentication information and credentials stored in the electronic device. The operating method of the electronic device may include encrypting the authentication information, the credentials, and the protection key based on keys of the electronic device including the protection key and the recovery key. The operating method of the electronic device may include transmitting the encrypted credentials, the encrypted authentication information, and the encrypted protection key to a server performing a secure remote password (SRP) protocol with the electronic device.

The encrypting of the authentication information, the credentials, and the protection key may include generating the encrypted credentials by encrypting the credentials with the protection key. The encrypting of the authentication information, the credentials, and the protection key may include generating the encrypted protection key by encrypting a multi-encrypted protection key and the recovery key based on a public key of a security device communicating with the server. The encrypting of the authentication information, the credentials, and the protection key may include: generating the encrypted authentication information by encrypting the authentication information with the recovery key.

The encrypting of the authentication information, the credentials, and the protection key may include encrypting the protection key with the recovery key. The encrypting of the authentication information, the credentials, and the protection key may include generating the multi-encrypted protection key by encrypting the protection key encrypted with the recovery key with the wrapping key.

The operating method may include storing, using the server, the encrypted credentials, and transmitting the encrypted protection key and the encrypted authentication information to the security device communicating with the server to re-encrypt the encrypted protection key and the encrypted authentication information.

The operating method may include obtaining, using the security device, the multi-encrypted protection key and the recovery key by decrypting the encrypted protection key with a private key of the security device. The operating method may include generating, using the security device, a first re-encrypted protection key by re-encrypting the recovery key and the multi-encrypted protection key with a symmetric key of the security device. The operating method may include transmitting, using the security device, the first re-encrypted protection key to the server, wherein the server may be configured to store the first re-encrypted protection key.

Based on another electronic device of the user being identified as a device of the user based on the SRP protocol, transmitting, using the server, the encrypted credentials to the another electronic device.

The operating method may include storing, using the server, the encrypted credentials based on lock release information of the another electronic device used to determine whether the another electronic device is the device of the user.

According to an aspect of the disclosure, an operating method of the electronic device may include based on obtaining lock release information used to store credentials from a user, performing an SRP protocol with a server communicating with the electronic device to share a session key with the server. The operating method of the electronic device may include obtaining from the server encrypted information in which encrypted credentials stored in the server and a second re-encrypted protection key are encrypted based on the session key. The operating method of the electronic device may include obtaining the encrypted credentials and the second re-encrypted protection key by decrypting the encrypted information with the session key. The operating method of the electronic device may include generating a wrapping key based on the lock release information, and obtaining the credentials by decrypting the second re-encrypted protection key and the encrypted credentials based on the wrapping key and keys stored in the electronic device.

According to an aspect of the disclosure, there is provided a non-transitory computer-readable storage medium storing instructions that, when executed by at least one processor, may cause the at least one processor to perform the operating method.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an embodiment;

FIG. 2 is a diagram illustrating an electronic device, a server, and a security device according to an embodiment;

FIG. 3 is a flowchart illustrating a registration process of credentials according to an embodiment;

FIG. 4 is a flowchart illustrating operations between an electronic device, a server, and a security device for the registration of credentials according to an embodiment;

FIG. 5 is a flowchart illustrating a recovery process of credentials according to an embodiment;

FIG. 6 is a flowchart illustrating operations between an electronic device, a server, and a security device for the recovery of credentials according to an embodiment;

FIGS. 7 and 8 illustrate screens of an electronic device to describe the registration and recovery of credentials according to an embodiment;

FIG. 9 is a diagram illustrating the recovery of credentials in one of a plurality of electronic devices according to an embodiment; and

FIGS. 10 and 11 are flowcharts illustrating the registration and recovery of quantum-resistant credentials according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

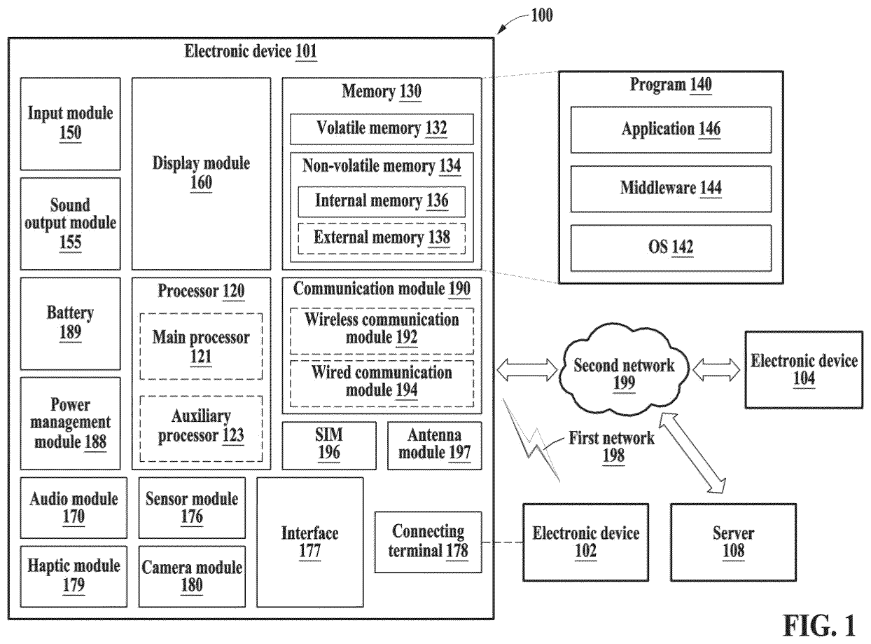

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated through machine learning. Such learning may be performed, for example, by the electronic device 101 in which an artificial intelligence model is executed, or via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to embodiments, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed at the electronic device 101 may be executed at one or more external electronic devices (e.g., the external devices 102 and 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

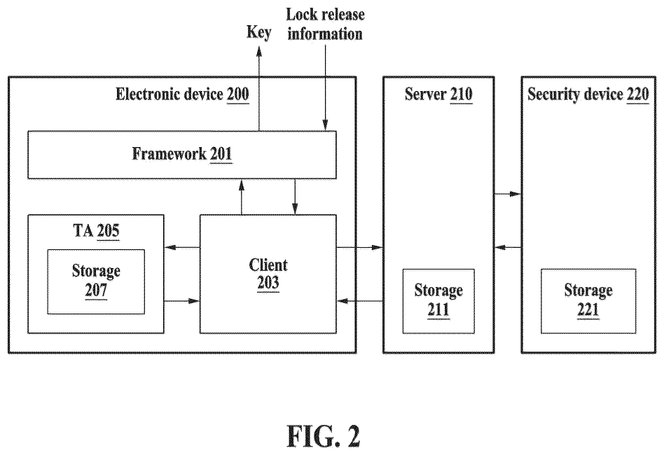

FIG. 2 is a diagram illustrating an electronic device, a server, and a security device according to an embodiment.

A service provided within an electronic device 200 (e.g., the electronic device 101 of FIG. 1) may use important information (e.g., certificates, login information, one time passwords (OTPs)) (i.e., credentials) of a user to provide services to the user. The credentials may be information used to verify a user's identity and grant authorization. The credentials may be an initial key generated for each service or user to use the services. Therefore, protecting the credentials may be a key to security.

A cryptographic algorithm may be used to securely protect the credentials. The credentials may need to be encrypted using a cryptographic algorithm and stored in a secure location. The cryptographic algorithm may encrypt the credentials using a cryptographic key. The cryptographic key may be generated based on a secure random number generator with sufficient entropy. The cryptographic key may also be generated based on the credentials.

To use a service on a plurality of electronic devices simultaneously or to use a service in the same manner on a new electronic device due to the loss or replacement of the electronic device, the credentials from the previous electronic device may have to be restored to the new electronic device. When the credentials stored in the previous electronic device are restored on the new electronic device, the user may use the service in the same manner. For example, the user may log in to the new electronic device using the same login information they used on the previous electronic device.

The present disclosure describes a method of registering credentials with a server and restoring the credentials.

Referring to FIG. 2, the electronic device 200, a server 210 (e.g., the server 108 of FIG. 1) and a security device 220 are illustrated.

The roles and functions of each component described below in the present disclosure may vary during the registration and recovery processes of credentials. A registration process of credentials may include storing credentials and authentication information for a secure remote password (SRP) protocol on the server 210. A recovery process of credentials may include identifying whether a user is a legitimate user through the SRP protocol and restoring the credentials stored in the server 210 to the electronic device 200.

According to an embodiment, the electronic device 200 may be a device that provides a service to a user. The electronic device 200 may include a framework 201, a client 203, a trust authority (TA) 205, and a storage 207 (e.g., the non-volatile memory 134 of FIG.

1). However, this is only an example and embodiments of the present disclosure are not limited thereto. The framework 201, the client 203, and the TA 205 may be implemented in software.

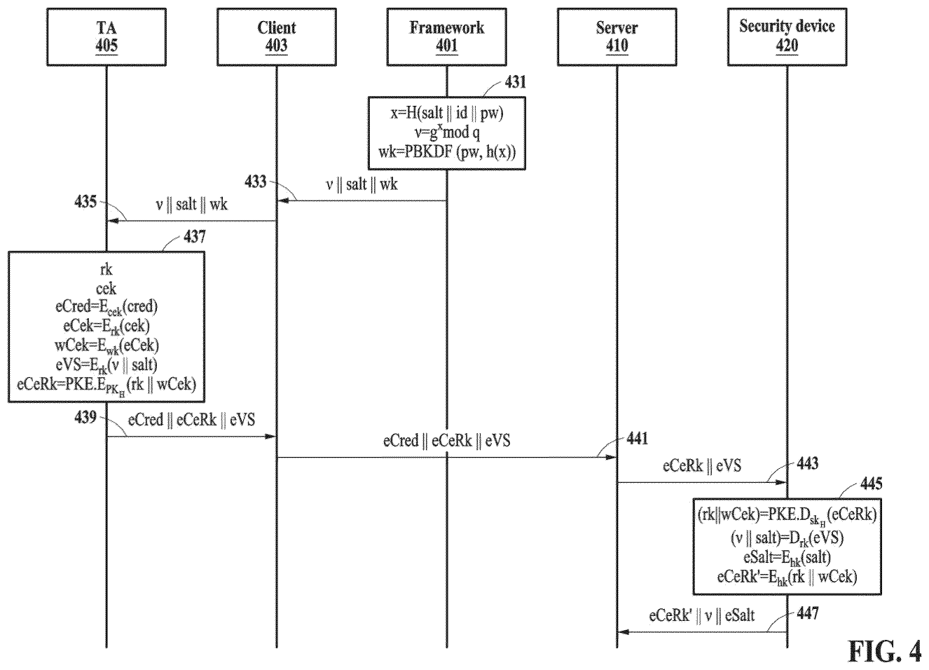

According to an embodiment, the framework 201 may be an agent that receives lock release information as input from a user during the registration and recovery processes of credentials. The framework 201 may perform pre-operations for performing the SRP protocol. The framework 201 may generate a key based on the lock release information as described later with reference to FIG. 4.

According to an embodiment, the client 203 may form a secure communication channel by performing a password-authenticated key exchange (PAKE) protocol with the server 210 during the recovery process of the credentials. For ease of description, in the present disclosure, the client 203 and the server 210 may communicate through the SRP protocol among various PAKE protocols. However, this is only an example and embodiments of the present disclosure are not limited thereto.

According to an embodiment, the TA 205 may perform encryption or decryption on keys used in the electronic device 200 during the registration process or recovery process of the credentials. The TA 205 may be an agent that stores, recovers, and manages the credentials.

According to an embodiment, the storage 207 may store various keys for encryption or decryption.

According to an embodiment, the server 210 may communicate with the electronic device 200 and the security device 220. For example, the server 210 may communicate with the electronic device 200 and the security device 220 via a short-range wireless communication network (e.g., the first network 198 of FIG. 1) and/or a long-range wireless communication network (e.g., the second network 199 of FIG. 1). The server 210 may perform the PAKE protocol with the client 203. The server 210 may include storage a 211. The storage 211 may store encrypted credentials.

According to an embodiment, the security device 220 may perform re-encryption on information received from the server 210 during the registration process and recovery process of the credentials. The security device 220 may include a storage 221. The storage 221 may store keys for re-encryption.

Hereinafter, the registration process of the credentials is described in detail.

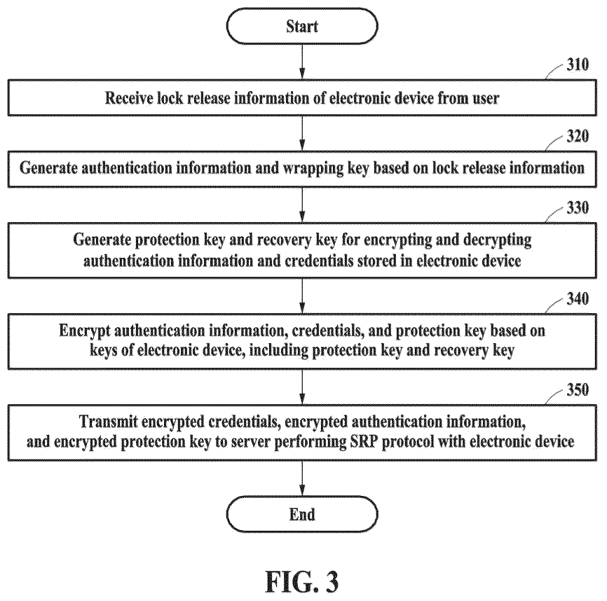

FIG. 3 is a flowchart illustrating a registration process of credentials according to an embodiment.

In the following embodiments, operations may be performed sequentially, but not necessarily performed sequentially. For example, the order of the operations may change and at least two of the operations may be performed in parallel. Operations 310 to 350 may be performed by at least one component (e.g., the processor 120 of FIG. 1) of an electronic device (e.g., the electronic device 101 of FIG. 1 and the electronic device 200 of FIG. 2). For example, instructions stored in a memory (e.g., the memory 130 of FIG. 1) may be executed by at least one processor, and the instructions may cause the electronic device to perform the following operations 310 to 350.

According to an embodiment, in operation 310, the electronic device may receive lock release information of the electronic device from a user.

According to an embodiment, a client (e.g., the client 203 of FIG. 2) of the electronic device may receive the lock release information as input to register authentication information based on an SRP protocol with a server (e.g., the server 210 of FIG. 2). The lock release information may be input from the user through a framework (e.g., the framework 201 of FIG. 2) of the electronic device. The lock release information may be information for unlocking the electronic device. The lock release information may include a pin, a pattern, a password, and facial recognition information.

According to an embodiment, in operation 320, the electronic device may generate authentication information and a wrapping key based on the lock release information.

According to an embodiment, the framework of the electronic device may generate the authentication information and wrapping key of the SRP protocol based on the lock release information. The authentication information of the SRP protocol may be used for authentication between the electronic device and the server during a subsequent recovery process of the credentials. The authentication information may include a verifier and a salt. The verifier may be generated based on a median value to be described later. The salt may be random data to increase security. For example, the salt may include a 256-bit random number.

According to an embodiment, in operation 330, the electronic device may generate a protection key and a recovery key for encrypting and decrypting the authentication information and credentials stored in the electronic device.

According to an embodiment, the client of the electronic device may transmit the generated authentication information and wrapping key to a TA (e.g., the TA 205 of FIG. 2). The TA of the electronic device may randomly generate a recovery key and a protection key. The TA of the electronic device may generate a recovery key and a protection key using various key generation algorithms. The protection key may be used to encrypt the credentials. The recovery key may be used to encrypt the protection key. The electronic device may store the recovery key and the protection key in a storage (e.g., the non-volatile memory 134 of FIG. 1 and the storage 207 of FIG. 2). The storage may store the recovery key, the protection key, a public key of the TA, and a private key of the TA. For ease of description, in the present disclosure, the public key of the TA and the private key of the TA may be referred to as the public key of the electronic device and the private key of the electronic device.

According to an embodiment, in operation 340, the electronic device may encrypt the authentication information, the credentials, and the protection key based on keys of the electronic device, including the protection key and the recovery key.

According to an embodiment, the TA of the electronic device may encrypt the authentication information, the credentials, and the protection key based on the keys of the electronic device, including the protection key and the recovery key. A method of encrypting the authentication information, the credentials, and the protection key is described later with reference to FIG. 4. The TA of the electronic device may generate encrypted authentication information, encrypted credentials, and an encrypted protection key based on the keys of the electronic device, including the protection key and the recovery key.

According to an embodiment, in operation 350, the electronic device may transmit the encrypted credentials, the encrypted authentication information, and the encrypted protection key to a server (e.g., the server 108 of FIG. 1 and the server 210 of FIG. 2) performing the SRP protocol with the electronic device.

According to an embodiment, the server may perform the SRP protocol with the electronic device when restoring the credentials to the electronic device. The server may communicate with a security device (e.g., the security device 220 of FIG. 2). The server may store the encrypted credentials and transmit the encrypted authentication information and the encrypted protection key to the security device.

According to an embodiment, the security device may re-encrypt the encrypted authentication information and the encrypted protection key and transmit the re-encrypted authentication information and the re-encrypted protection key to the server. An operation of the security device obtaining the encrypted authentication information and the encrypted protection key is described later with reference to FIG. 4.

FIG. 4 is a flowchart illustrating operations between an electronic device, a server, and a security device for the registration of credentials according to an embodiment.

Referring to FIG. 4, a framework 401 (e.g., the framework 201 of FIG. 2), a client 403 (e.g., the client 203 of FIG. 2), and a TA 405 (e.g., the TA 205 of FIG. 2) of an electronic device (e.g., the electronic device 101 of FIG. 1 and the electronic device 200 of FIG. 2) are illustrated. Referring to FIG. 4, a server 410 (e.g., the server 108 of FIG. 1 and the server 210 of FIG. 2) and a security device 420 (e.g., the security device 220 of FIG. 2) are illustrated.

According to an embodiment, when instructions stored in a memory (e.g., the memory 130 of FIG. 1) are executed by at least one processor (e.g., the processor 120 of FIG. 1), the instructions may cause the framework 401, the client 403, and the TA 405 of the electronic device to perform the following operations.

According to an embodiment, in operation 431, the framework 401 may generate authentication information and a wrapping key wk.

According to an embodiment, the framework 401 may generate the authentication information and the wrapping key wk based on lock release information pw received from a user. The authentication information may include a verifier v and a salt salt. The authentication information may be used for authentication between the server and the electronic device in an SRP protocol. The framework 401 may generate a median value x based on a user's identification (ID) id, the lock release information pw, and the salt salt. The framework 401 may generate the median value x using a hash algorithm.

According to an embodiment, the user's ID id may include unique information corresponding to the user, such as ID information for logging into the server 410 and a serial number of the electronic device. According to an embodiment, the lock release information pw may include a pin, a pattern, a password, and facial recognition information as information for unlocking the electronic device. According to an embodiment, the salt salt may be random data to increase security. For example, the salt salt may include a 256-bit random number.

According to an embodiment, the framework 401 may generate the verifier v based on the median value x. For example, the framework 401 may generate the verifier v through a modulo operation based on the median value x.

According to an embodiment, the framework 401 may generate the wrapping key wk based on a hash value h(x) of the median value x and the lock release information pw. The framework 401 may generate the wrapping key wk by applying an algorithm (e.g., a password-based key derivation function (PBKDF) algorithm) for generating an encryption key to the hash value h(x) of the median value x and the lock release information pw.

According to an embodiment, in operation 433, the framework 401 may transmit the authentication information and the wrapping key wk to the client 403 (e.g., the client 203 of FIG. 2).

According to an embodiment, in operation 435, the client 403 may transmit the authentication information and the wrapping key wk to the TA 405 (e.g., the TA 205 of FIG. 2).

According to an embodiment, in operation 437, the TA 405 may generate a protection key (hereinafter, cek) and a recovery key rk to encrypt and decrypt credentials cred and the authentication information, and encrypt the authentication information, the credentials cred, and the protection key cek based on keys of the electronic device, including the protection key cek and the recovery key rk.

According to an embodiment, in FIG. 4, E_{key}(data) may indicate that data data is encrypted using a cryptographic key key through symmetric key encryption (e.g., advanced encryption standard (AES), lightweight encryption algorithm (LEA)). In FIG. 4, PKE. E_{key}(data) may indicate that data data is encrypted using a cryptographic key key through public key encryption (e.g., Rivest, Shamir, Adleman (RSA)—optimal asymmetric encryption padding (OAEP)). Similarly, D_{key}(data) may indicate that data data is decrypted using a cryptographic key key through symmetric key encryption (e.g., AES, LE). PKE. D_{key}(data) may indicate that data data is decrypted using a cryptographic key key through public key encryption (e.g., RSA-OAEP).

According to an embodiment, the TA 405 may randomly generate the protection key cek and the recovery key rk. The TA 405 may encrypt the authentication information, the credentials cred, and the protection key cek based on keys of the electronic device. The keys of the electronic devices may include the protection key cek, the recovery key rk, the wrapping key wk, a public key pk_{T} (e.g., the public key of the TA 405) of the electronic device, and a private key sk_{T} (e.g., the private key of the TA 405) of the electronic device.

According to an embodiment, the TA 405 may generate encrypted credentials eCred by encrypting the credentials cred with the protection key cek.

According to an embodiment, the TA 405 may generate encrypted authentication information eVS by encrypting the authentication information with the recovery key. The TA 405 may generate the encrypted authentication information eVS by encrypting the verifier v and the salt salt of the authentication information with the recovery key.

According to an embodiment, the TA 405 may generate a multi-encrypted protection key wCek. The TA 405 may encrypt the protection key cek with the recovery key rk and re-encrypt a primary encrypted protection key eCek with the wrapping key wk to generate the multi-encrypted protection key wCek.

According to an embodiment, the TA 405 may generate an encrypted protection key eCeRk by encrypting the multi-encrypted protection key wCek and the recovery key rk based on a public key PK_{H} of the security device 420 communicating with the server 410.

According to an embodiment, in operation 439, the TA 405 may transmit the encrypted credentials eCred, the encrypted protection key eCeRk, and the encrypted authentication information eVS to the client 403.

According to an embodiment, in operation 441, the client 403 may transmit the encrypted credentials eCred, the encrypted protection key eCeRk, and the encrypted authentication information eVS to the server 410.

Since the encrypted information is transmitted to the server 410, the transmission of information may be robust against attacks.

According to an embodiment, in operation 443, the server 410 may store the encrypted credentials eCred and transmit the encrypted protection key eCeRk and the encrypted authentication information eVS to the security device 420. The server 410 may request the security device 420 to re-encrypt the encrypted protection key eCeRk and the encrypted authentication information eVS.

According to an embodiment, in operation 445, the security device 420 may re-encrypt the encrypted protection key eCeRk and the encrypted authentication information eVS.

According to an embodiment, the security device 420 may encrypt the encrypted protection key eCeRK with a private key sk_{H} of the security device 420. The security device 420 may obtain the recovery key rk and the multi-encrypted protection key wCek by decrypting the encrypted protection key eCeRk.

According to an embodiment, the security device 420 may decrypt the encrypted authentication information eVS with the recovery key rk. The security device 420 may obtain the verifier v and the salt salt by decrypting the encrypted authentication information eVS.

According to an embodiment, a storage (e.g., the storage 221 of FIG. 2) of the security device 420 may store a symmetric key hk, the public key pk_{H} of the security device, and the private key sk_{H} of the security device. The security device 420 may obtain an encrypted salt eSalt by re-encrypting the salt salt with the symmetric key hk of the security device. The security device 420 may obtain a first re-encrypted protection key eCeRk′ by re-encrypting the recovery key rk and the multi-encrypted protection key wCek with the symmetric key hk of the security device.

According to an embodiment, in operation 447, the security device 420 may transmit the first re-encrypted protection key eCeRk′, the encrypted salt eSalt, and the verifier v to the server 410.

According to an embodiment, the server 410 may store the first re-encrypted protection key eCeRk′, the encrypted salt eSalt, and the verifier v received from the security device 420. Ultimately, the storage of the server 410 may store the encrypted credentials eCred, the first re-encrypted protection key eCeRk′, the encrypted salt eSalt, and the verifier v.

According to an embodiment, the lock release information pw of the electronic device may change after the credentials are encrypted and stored in the server 410. When the lock release information pw of the electronic device is changed, the credentials eCred, the first re-encrypted protection key eCeRk′, the encrypted salt eSalt, and the verifier v stored in the server by the above-described operations 431 to 447 may be updated. However, the protection key cek and the recovery key rk used to encrypt the credentials may not be re-generated and may be used to update the protection key cek and the recovery key rk stored in the storage of the electronic device.

During the registration process of the credentials described above, the keys used to encrypt the credentials and the re-encrypt the encrypted credentials may be encrypted by keys unknown to the server 410. Therefore, even when information stored in the server 410 is leaked, decryption may be difficult. Therefore, the level of security may be high.

Hereinafter, the recovery process of credentials is described in detail.

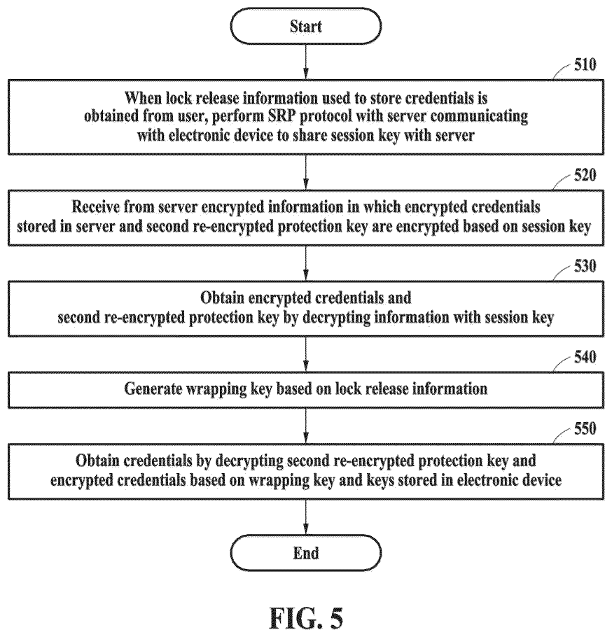

FIG. 5 is a flowchart illustrating a recovery process of credentials according to an embodiment.

In the following embodiments, operations may be performed sequentially, but not necessarily performed sequentially. For example, the order of the operations may change and at least two of the operations may be performed in parallel. Operations 510 to 550 may be performed by at least one component (e.g., the processor 120 of FIG. 1) of an electronic device (e.g., the electronic device 101 of FIG. 1 and the electronic device 200 of FIG. 2). For example, instructions stored in a memory (e.g., the memory 130 of FIG. 1) may be executed by at least one processor, and the instructions may cause the electronic device to perform the following operations 510 to 550.

According to an embodiment, in operation 510, when the electronic device obtains lock release information used to store credentials from a user, the electronic device may perform an SRP protocol with a server communicating with the electronic device to share a session key with the server.

According to an embodiment, the electronic device may request the user to provide the lock release information used to register the credentials with the server. The electronic device may perform a recovery process of the credentials when the lock release information obtained from the user is identical to the lock release information used to register the credentials with the server (e.g., the server 108 of FIG. 1 and the server 210 of FIG. 2).

According to an embodiment, the electronic device may perform an SRP protocol with the server using the lock release information obtained from the user. The electronic device may be authenticated as a legitimate user by performing the SRP protocol with the server. When the electronic device is authenticated as the legitimate user, the electronic device and the server may share a session key.

According to an embodiment, in operation 520, the electronic device may receive from the server encrypted information in which encrypted credentials stored in the server and a second re-encrypted protection key are encrypted based on a session key.

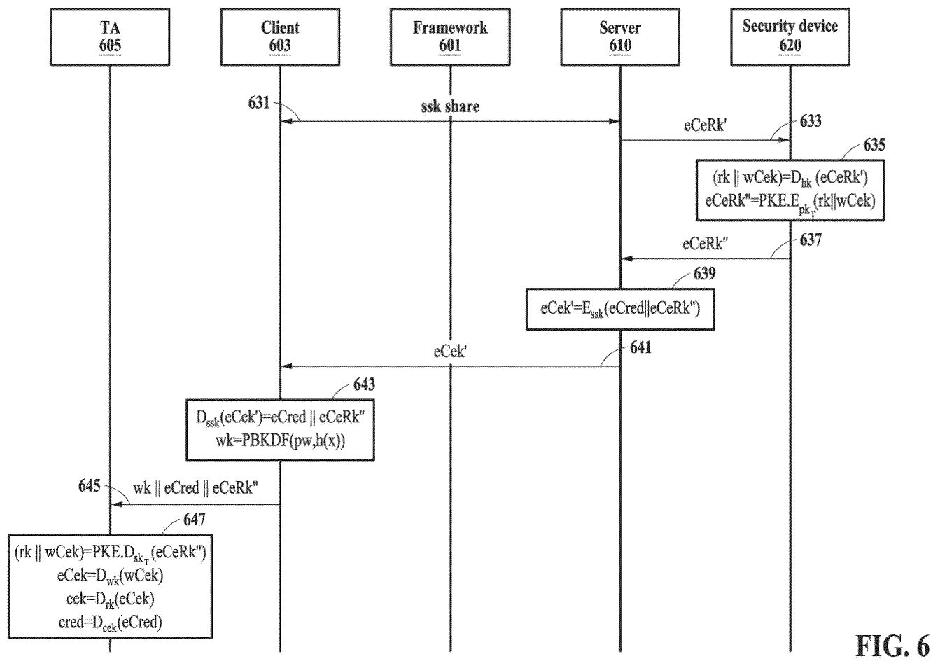

According to an embodiment, the server may request re-encryption of a first re-encrypted protection key to a security device (e.g., the security device 220 of FIG. 2) communicating with the server. The security device may generate the second re-encrypted protection key by re-encrypting the first re-encrypted protection key. A method by which the security device generates the second re-encrypted protection key is described later with reference to FIG. 6.

According to an embodiment, the server may receive the second re-encrypted protection key from the security device. The server may generate encrypted information by encrypting the second re-encrypted protection key and the encrypted credentials stored in the server with the session key. The server may transmit the encrypted information to the electronic device.

According to an embodiment, in operation 530, the electronic device may obtain the encrypted credentials and the second re-encrypted protection key by decrypting the information with the session key.

According to an embodiment, in operation 540, the electronic device may generate a wrapping key based on the lock release information.

According to an embodiment, the electronic device may generate the wrapping key based on the lock release information obtained in operation 510.

According to an embodiment, in operation 550, the electronic device may obtain the credentials by decrypting the second re-encrypted protection key and the encrypted credentials based on the wrapping key and the keys stored in the electronic device.

In other words, the credentials may be recovered. As the credentials are recovered, users may use the services they used on their previous electronic device on their current electronic device in the same manner. In other words, the users may use the services without having to newly register credentials. For example, the users may log in to a new electronic device using the same login information they used on the previous electronic device.

FIG. 6 is a flowchart illustrating operations between an electronic device, a server, and a security device for the recovery of credentials according to an embodiment.

Referring to FIG. 6, a framework 601 (e.g., the framework 201 of FIG. 2 and the framework 401 of FIG. 4), a client 603 (e.g., the client 203 of FIG. 2 and the client 403 of FIG. 4), and a TA 605 (e.g., the TA 205 of FIG. 2 and the TA 405 of FIG. 4) of an electronic device (e.g., the electronic device 101 of FIG. 1 and the electronic device 200 of FIG. 2) are illustrated. Referring to FIG. 6, a server 610 (e.g., the server 108 of FIG. 1, the server 210 of FIG. 2, and the server 410 of FIG. 4) and a security device 620 (e.g., the security device 220 of FIG. 2 and the security device 420 of FIG. 4) are illustrated. The server 610 may be in a state in which the credentials are registered with the server 610, and the server 610 stores the encrypted credentials eCred, the first re-encrypted protection key eCeRk′, the encrypted salt eSalt, and the verifier v.

According to an embodiment, when instructions stored in a memory (e.g., the memory 130 of FIG. 1) are executed by at least one processor (e.g., the processor 120 of FIG. 1), the instructions may cause the framework 601, the client 603, and the TA 605 of the electronic device to perform the following operations.

According to an embodiment, in operation 631, the client 603 and the server 610 may share a session key ssk.

According to an embodiment, the electronic device may obtain lock release information pw from a user. The lock release information pw obtained from the user may be lock release information pw used to store the credentials. The electronic device may perform an SRP protocol with the server using the lock release information pw. The electronic device may be authenticated as a legitimate user by performing the SRP protocol with the server. When the electronic device is authenticated as the legitimate user, the electronic device and the server may share the session key ssk.

According to an embodiment, in operation 633, the server 610 may transmit a first re-encrypted protection key eCeRk′ to the security device 620.

According to an embodiment, the server 610 may request re-encryption by transmitting the first re-encrypted protection key eCeRk′ to the security device 620.

According to an embodiment, in FIG. 6, E_{key}(data) may indicate that data data is encrypted using a cryptographic key key through symmetric key encryption (e.g., AES, LEA). In FIG. 4, PKE. E_{key}(data) may indicate that data data is encrypted using a cryptographic key key through public key encryption (e.g., RSA-OAEP). Similarly, D_{key}(data) may indicate that data data is decrypted using a cryptographic key key through symmetric key encryption (e.g., AES, LEA). PKE. D_{key}(data) may indicate that data data is decrypted using a cryptographic key key through public key encryption (e.g., RSA-OAEP).

According to an embodiment, in operation 635, the security device 620 may generate a second re-encrypted protection key eCeRk″ by re-encrypting the first re-encrypted protection key eCeRk′.

According to an embodiment, the security device 620 may decrypt the first re-encrypted protection key eCeRk′ with a symmetric key hk of the security device 620. The security device 620 may obtain a multi-encrypted protection key wCek and a recovery key rk by decrypting the first re-encrypted protection key eCeRk′.

According to an embodiment, the security device 620 may generate the second re-encrypted protection key eCeRk″ by encrypting the multi-encrypted protection key wCek and the recovery key rk with a public key pk_{T} (e.g., a public key of the TA 605) of the electronic device.

According to an embodiment, in operation 637, the security device 620 may transmit the second re-encrypted protection key eCeRk″ to the server 610.

According to an embodiment, in operation 639, the server 610 may encrypt the encrypted credentials eCred and the second re-encrypted protection key eCeRk″ with the session key ssk.

According to an embodiment, the server 610 may generate encrypted information eCek′ by encrypting the encrypted credentials eCred and the second re-encrypted protection key eCeRk″. The server 610 may transmit the encrypted information eCek′ to the electronic device.

According to an embodiment, in operation 641, the server 610 may transmit the encrypted information eCek′ to the client 603.

According to an embodiment, in operation 643, the client 603 may generate a wrapping key wk by decrypting the encrypted information eCek′.

According to an embodiment, the client 603 may decrypt the encrypted information eCek′ with the session key ssk. The client 603 may obtain the encrypted credentials eCred and the second re-encrypted protection key eCeRk″ by decrypting the encrypted information eCek′.

According to an embodiment, the client 603 may generate the wrapping key wk based on the lock release information pw obtained from the user. The lock release information pw may be information input from the user when the session key ssk is shared. The method of generating the wrapping key wk is described above with reference to FIG. 4 and thus is omitted herein.

According to an embodiment, in operation 645, the client 603 may transmit the wrapping key wk, the encrypted credentials eCred, and the second re-encrypted protection key eCeRk″ to the TA 605.

According to an embodiment, in operation 647, the TA 605 may recover the credentials.

According to an embodiment, the TA 605 may decrypt the second re-encrypted protection key eCeRk″ using a private key sk_{T} of the electronic device. The TA 605 may obtain the multi-encrypted protection key wCek and the recovery key rk by decrypting the second re-encrypted protection key.

According to an embodiment, the TA 605 may obtain a primary encrypted protection key eCek by decrypting the multi-encrypted protection key wCek with the wrapping key wk. The TA 605 may decrypt the primary encrypted protection key eCek with the recovery key rk. The TA 605 may obtain a protection key cek by decrypting the primary encrypted protection key eCek.

According to an embodiment, the TA 605 may obtain credentials cred by decrypting the encrypted credentials eCred with the protection key cek.

In other words, the credentials may be recovered. As the credentials are recovered, users may use the services they used on their previous electronic device on their current electronic device in the same manner. In other words, the users may use the services without having to newly register the credentials.

Additionally, the first re-encrypted protection key that is being stored in the server may be encrypted with the public key pk_{T} (e.g., the public key of the TA 605) of the electronic device in the security device and then encrypted again with the session key ssk, thereby increasing the level of security by being double protected.

Additionally, end-to-end encryption may be applied during the registration and recovery processes of the credentials, which may increase the level of security by not exposing any information to the server.

Hereinafter, screens of the electronic device during the registration and recovery processes of credentials are described.

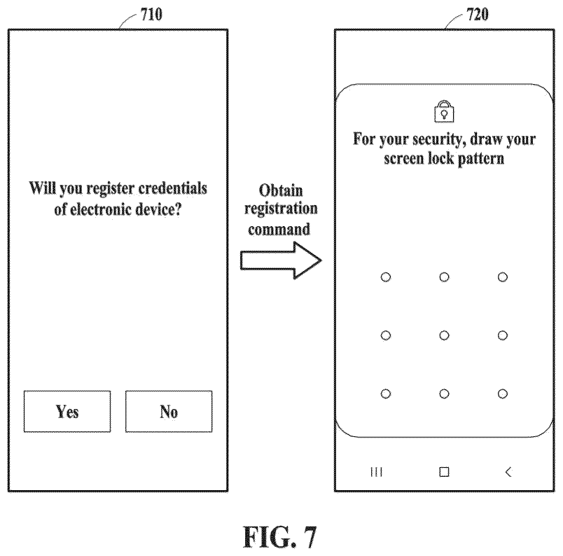

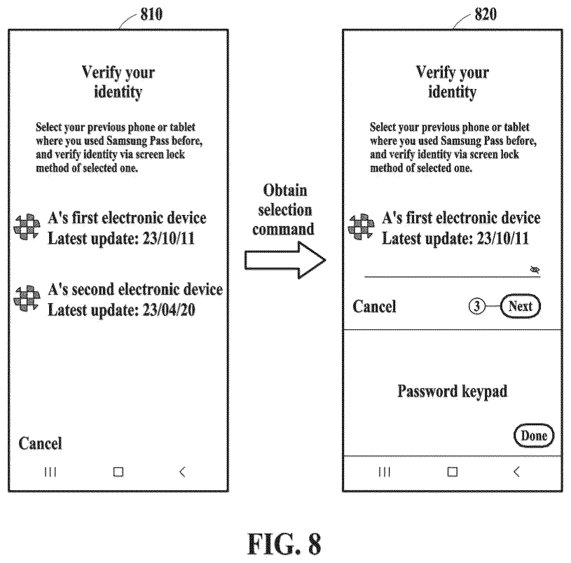

FIGS. 7 and 8 illustrate screens of an electronic device to describe the registration and recovery of credentials according to an embodiment.

Referring to FIG. 7, screens 710 and 720 of an electronic device (e.g., the electronic device 101 of FIG. 1 and the electronic device 200 of FIG. 2) are illustrated.

According to an embodiment, the screen 710 may be an execution screen of an application, program, and software (e.g., the program 140 and application 146 of FIG. 1) that provide a registration service for credentials. The application, program, and software that provide the registration service for credentials may provide management services such as registration and recovery of credentials. For example, the application, program, and software that provide the registration service for credentials may provide management services for authentication information for website logins.

According to an embodiment, in the screen 710, the electronic device may obtain a registration command to register credentials with a server (e.g., the server 108 of FIG. 1, the server 210 of FIG. 2, the server 410 of FIG. 4, and the server 610 of FIG. 6). For example, the electronic device may obtain a selection command for “YES” on the screen 710. When the registration command is obtained, the electronic device may display the screen 720.

According to an embodiment, the screen 720 may be a screen for receiving lock release information of the electronic device as input. The lock release information of the electronic device may vary depending on a current unlocking scheme of the electronic device. For example, the lock release information of the electronic device may be determined to be at least one of a pin, a pattern, a password, and facial recognition information.

According to an embodiment, the electronic device may receive the lock release information through the screen 720. When the lock release information received through the screen 720 matches the lock release information of the electronic device, the electronic device may register the credentials with the server. In other words, the electronic device may register the credentials with the server based on the operations described above with reference to FIGS. 4 and 5.

Referring to FIG. 8, screens 810 and 820 of an electronic device (e.g., the electronic device 101 of FIG. 1 and the electronic device 200 of FIG. 2) are illustrated. The electronic device displaying the screens 810 and 820 may be a device for recovering credentials.

According to an embodiment, the screen 810 may be an execution screen of an application, program, and software (e.g., the program 140 and application 146 of FIG. 1) that provide a recovery service for credentials.

According to an embodiment, the screen 810 may display a list of credentials registered with a server (e.g., the server 108 of FIG. 1, the server 210 of FIG. 2, the server 410 of FIG. 4, and the server 610 of FIG. 6). The list may display registration information for an electronic device of a user registered with the server. In other words, when one or more credentials for one or more electronic devices are registered to a user's account, the list may include registration information for the one or more electronic devices.

For example, when user A has two electronic devices (e.g., a first electronic device and a second electronic device) and credentials for each electronic device are registered in the server, the screen 810 may display registration information for each electronic device. The registration information may include a name of the electronic device and a date on which the credentials of the electronic device are updated (or registered).

According to an embodiment, when a plurality of registration information is displayed in the list, the electronic device may obtain a selection command for one of the plurality of registration information from the user.

According to an embodiment, the screen 820 may be a screen for receiving lock release information of the electronic device as input.

According to an embodiment, the electronic device may receive the lock release information through the screen 820. In other words, the electronic device may obtain a command to recover the credentials. When the lock release information is received through the screen 820, the electronic device may perform an SRP protocol with the server. When the electronic device is identified as a legitimate user through the SRP protocol, the electronic device may recover the credentials through the methods described above with reference to FIGS. 5 and 6.

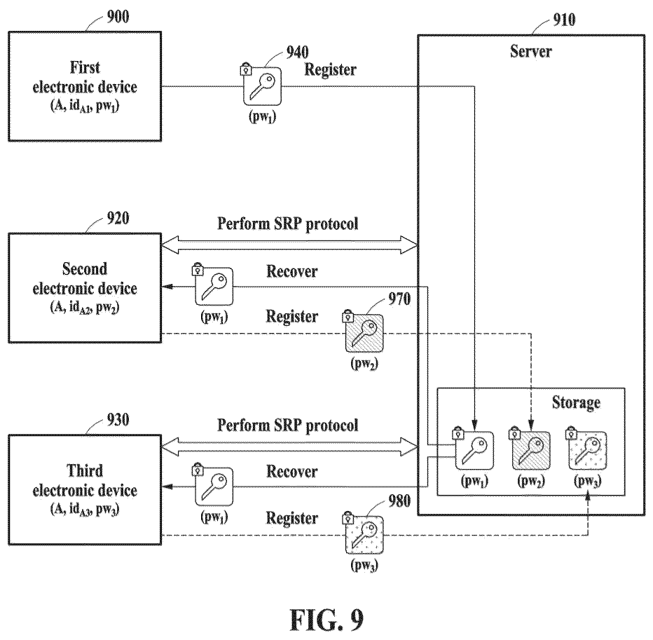

FIG. 9 is a diagram illustrating the recovery of credentials in one of a plurality of electronic devices according to an embodiment.

According to an embodiment, the recovery of credentials may be possible across heterogeneous devices. For example, the recovery of credentials may be possible across heterogeneous devices such as smartphones, smartwatches, tablet personal computers (PCs), and head mounted displays (HMDs). In FIG. 9, a security device (e.g., the security device 220 of FIG. 2, the security device 420 of FIG. 4, and the security device 620 of FIG. 6) is omitted for ease of description.

A first electronic device 900 (e.g., the electronic device 101 of FIG. 1 and the electronic device 200 of FIG. 2), a second electronic device 920, and a third electronic device 930 of FIG. 9 may be devices registered to an account of user A and may be heterogeneous devices. In other words, the first electronic device 900, the second electronic device 920, and the third electronic device 930 may be devices owned by user A and registered to the account of user A through an authentication process.

According to an embodiment, a user ID and lock release information for each electronic device may be different. For example, the ID of the first electronic device 900 of user A may be id_{A1}, and the lock release information may be pw₁. For example, the ID of the second electronic device 920 of user A may be id_{A2}, and the lock release information may be pw₂. For example, the ID of the third electronic device 930 of user A may be id_{A3}, and the lock release information may be pw₃.

According to an embodiment, the first electronic device 900 may be a device that registers credentials with a server 910 (e.g., the server 108 of FIG. 1, the server 210 of FIG. 2, the server 410 of FIG. 4, and the server 610 of FIG. 6).

The method of registering the credentials of the first electronic device 900 with the server 910 is described above with reference to FIGS. 3 and 4 and thus is omitted herein. The credentials of the first electronic device 900 may be encrypted and stored in the server 910 as encrypted credentials 940.

According to an embodiment, the server 910 may store the credentials along with a user ID and/or device ID for the electronic device.

According to an embodiment, the second electronic device 920 may be a heterogeneous electronic device from the first electronic device 900. For example, when the first electronic device 900 is a smartphone, the second electronic device 920 may be a tablet PC.

According to an embodiment, the second electronic device 920 may receive the lock release information pw₂ from the user. The second electronic device 920 may perform an SRP protocol with the server 910 based on the user ID id_{A2} and/or the lock release information pw₂. When the second electronic device 920 is identified as an electronic device owned by user A through the SRP protocol, the second electronic device 920 may obtain the encrypted credentials 940. That is, when the second electronic device 920 is identified as an electronic device owned by user A, the server 910 may transmit the encrypted credentials 940 to the second electronic device 920. The second electronic device 920 may obtain the credentials by decrypting the encrypted credentials 940. In other words, the second electronic device 920 may recover the credentials of the first electronic device 900.

The method by which the second electronic device 920 obtains the encrypted credentials and recovers the credentials is described above with reference to FIGS. 5 and 6 and thus is omitted herein.

According to an embodiment, after obtaining the credentials, the second electronic device 920 may encrypt the credentials based on the lock release information pw₂ and store the encrypted credentials in the server 910. The lock release information pw₂ may be information used to determine whether the second electronic device 920 is the user's electronic device. In other words, the lock release information may be information used in the SRP protocol.

According to an embodiment, the second electronic device 920 may generate encrypted credentials 970 by encrypting the obtained credentials based on the lock release information pw₂ and register the encrypted credentials 970 with the server 910. The method of registering the credentials with the server 910 is described above with reference to FIGS. 3 and 4 and thus is omitted herein.

Similarly, the third electronic device 930 may be a heterogeneous electronic device from the first electronic device 900. For example, when the first electronic device 900 is a smartphone, the second electronic device 920 may be an HMD. The method by which the third electronic device 930 recovers the credentials and stores encrypted credentials 980 in the server 910 is described above in the description of the second electronic device 920 and thus is omitted herein.

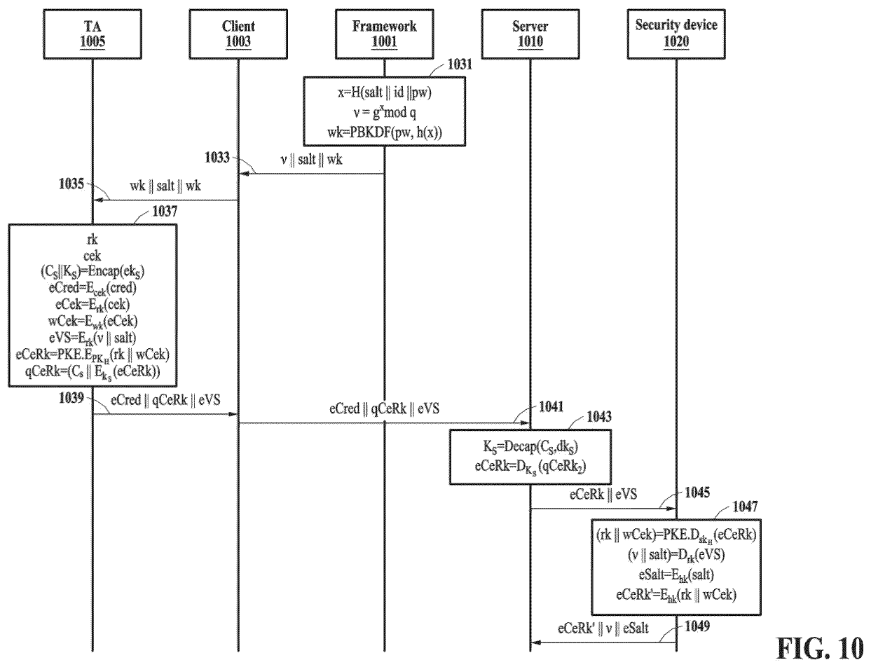

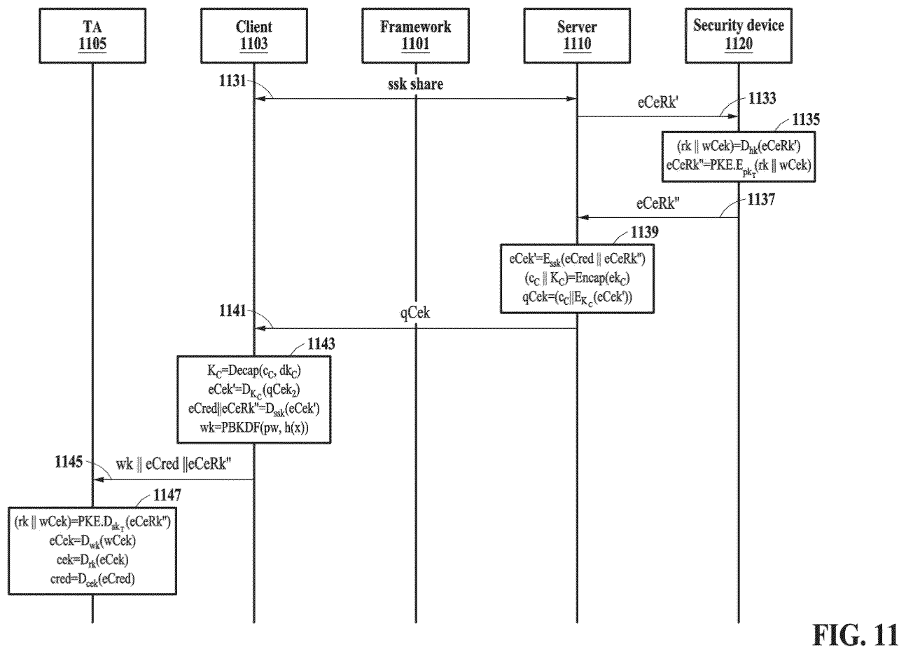

FIGS. 10 and 11 are flowcharts illustrating the registration and recovery of quantum-resistant credentials according to an embodiment.

Referring to FIG. 10, a framework 1001 (e.g., the framework 201 of FIG. 2, the framework 401 of FIG. 4, and the framework 601 of FIG. 6), a client 1003 (e.g., the client 203 of FIG. 2, the client 403 of FIG. 4, and the client 603 of FIG. 6), and a TA 1005 (e.g., the TA 205 of FIG. 2, the TA 405 of FIG. 4, and the TA 605 of FIG. 6) of an electronic device (e.g., the electronic device 101 of FIG. 1, the electronic device 200 of FIG. 2, and the first electronic device 900 of FIG. 9) are illustrated. Referring to FIG. 10, a server 1010 (e.g., the server 108 of FIG. 1, the server 210 of FIG. 2, the server 410 of FIG. 4, the server 610 of FIG. 6, and the server 910 of FIG. 9) and a security device 1020 (e.g., the security device 220 of FIG. 2, the security device 420 of FIG. 4, and the security device 620 of FIG. 6) are illustrated.

According to an embodiment, when instructions stored in a memory (e.g., the memory 130 of FIG. 1) are executed by at least one processor (e.g., the processor 120 of FIG. 1), the instructions may cause the framework 401, the client 403, and the TA 405 of the electronic device to perform the following operations.

Since operations 1031 to 1035 may be applied in the same manner as operations 431 to 435 of FIG. 4, the description of operations 1031 to 1035 is omitted.

According to an embodiment, in operation 1037, the TA 1005 may generate a protection key cek and a recovery key rk to encrypt and decrypt credentials cred and authentication information, and may encrypt the authentication information, the credentials cred, and the protection key cek based on keys of the electronic device, including the protection key cek and the recovery key rk.

According to an embodiment, in FIG. 10, E_{key}(data) may indicate that data data is encrypted using a cryptographic key key through symmetric key encryption (e.g., AES, LEA). In FIG. 10, PKE. E_{key}(data) may indicate that data data is encrypted using a cryptographic key key through public key encryption (e.g., RSA-OAEP). Similarly, D_{key}(data) may indicate that data data is decrypted using a cryptographic key key through symmetric key encryption (e.g., AES, LEA). PKE. D_{key}(data) may indicate that data data is decrypted using a cryptographic key through public key encryption (e.g., RSA-OAEP). In addition, Encap(pubkey) may be an algorithm that outputs a shared key corresponding to a public key pubkey using quantum computing-secure key encapsulation (e.g., module-lattice-based key-encapsulation mechanism (ML-KEM)). Decap(ciphertext, privkey) may be an algorithm that outputs a shared key corresponding to a public key pubkey from a ciphertext and a private key privkey, and may be a reverse process of Encap(pubkey).

According to an embodiment, the TA 1005 may generate a protection key cek and a recovery key rk. The TA 1005 may generate a shared key K_{S} and a ciphertext C_{S} through key encapsulation. The TA 1005 may generate the shared key K_{S} with the server and the ciphertext C_{S} based on a public key ek_{S} of the server 1010 through key encapsulation.

The method by which the TA 1005 generates the encrypted authentication information eVS, the encrypted credentials eCred, and the encrypted protection key eCeRk is described above with reference to FIG. 4 and thus is omitted herein.

According to an embodiment, the TA 1005 may additionally encrypt the encrypted protection key based on the shared key K_{S} and the ciphertext C_{S}. The TA 1005 may generate qCeRk₂ by encrypting the encrypted protection key eCeRk using the shared key K_{S}. The ciphertext C_{S} may be qCeRk₁. Here, qCeRk, which may be the final encrypted form of the protection key cek, may include qCeRk₁ and qCeRk₂. The encrypted protection key eCeRk may be referred to as a first encrypted protection key. qCeRk, which may be an additionally encrypted protection key, may be referred to as a second encrypted protection key.

According to an embodiment, in operation 1039, the TA 1005 may transmit qCeRk, the encrypted authentication information eVS, and the encrypted credentials eCred to the client 1003.

According to an embodiment, in operation 1041, the client 1003 may transmit qCeRk, the encrypted authentication information eVS, and the encrypted credentials eCred to the server 1010.

According to an embodiment, in operation 1043, the server 1010 may obtain the shared key K_{S} between the server 1010 and the TA 1005 by inputting qCeRk₁ (e.g., the ciphertext C_{S}) included in qCeRk and the private key dkₛ of the server to a Decap function.

According to an embodiment, in operation 1043, the server 1010 may obtain the encrypted protection key eCeRk by decrypting qCeRk₂ included in qCeRk with the shared key K_{S}.

According to an embodiment, in operation 1043, the server 1010 may store the encrypted credentials eCred.

According to an embodiment, in operation 1045, the server 1010 may transmit the encrypted protection key eCeRk and the encrypted authentication information eVS to the security device 1020. The server 1010 may request the security device 420 to re-encrypt the encrypted protection key eCeRk and the encrypted authentication information eVS.

According to an embodiment, in operation 1047, the security device 1020 may re-encrypt the encrypted protection key eCeRk and the encrypted authentication information eVS.

Since the description of operation 1047 is provided above with reference to FIG. 4, the description is omitted herein.

According to an embodiment, in operation 1049, the security device 1020 may transmit a first re-encrypted protection key eCeRk′, an encrypted salt eSalt, and a verifier v to the server 1010. The server 1010 may store the first re-encrypted protection key eCeRk′, the encrypted salt eSalt, and the verifier v received from the security device 1020. Ultimately, a storage (e.g., the storage 211 of FIG. 2) of the server 1010 may store the encrypted credentials eCred, the first re-encrypted protection key eCeRk′, the encrypted salt eSalt, and the verifier v.

Hereinafter, a recovery process of credentials is described.

Referring to FIG. 11, a framework 1101 (e.g., the framework 201 of FIG. 2, the framework 401 of FIG. 4, the framework 601 of FIG. 6, and the framework 1001 of FIG. 10), a client 1103 (e.g., the client 203 of FIG. 2, the client 403 of FIG. 4, the client 603 of FIG. 6, and the client 1003 of FIG. 10) and a TA 1105 (e.g., the TA 205 of FIG. 2, the TA 405 of FIG. 4, the TA 605 of FIG. 6, and the TA 1005 of FIG. 10) of an electronic device (e.g., the electronic device 101 of FIG. 1, the electronic device 200 of FIG. 2, and the first electronic device 900 of FIG. 9) are illustrated. Referring to FIG. 11, a server 1110 (e.g., the server 108 of FIG. 1, the server 210 of FIG. 2, the server 410 of FIG. 4, the server 610 of FIG. 6, the server 910 of FIG. 9, and the server 1010 of FIG. 10) and a security device 1120 (e.g., the security device 220 of FIG. 2, the security device 420 of FIG. 4, the security device 620 of FIG. 6, and the security device 1020 of FIG. 10) are illustrated.

Since operations 1131 to 1137 may be applied in the same manner as operations 631 to 637 of FIG. 6, the description of operations 1131 to 1137 is omitted.

According to an embodiment, in FIG. 11, E_{key}(data) may indicate that data data is encrypted using a cryptographic key key through symmetric key encryption (e.g., AES, LEA). In FIG. 11, PKE. E_{key}(data) may indicate that data data is encrypted using a cryptographic key key through public key encryption (e.g., RSA-OAEP). Similarly, D_{key}(data) may indicate that data data is decrypted using a cryptographic key key through symmetric key encryption (e.g., AES, LEA). PKE. D_{key}(data) may indicate that data data is decrypted using a cryptographic key key through public key encryption (e.g., RSA-OAEP). In addition, Encap(pubkey) may be an algorithm that outputs a shared key corresponding to a public key pubkey using quantum computing-secure key encapsulation (e.g., ML-KEM). Decap(ciphertext, privkey) may be an algorithm that outputs a shared key corresponding to a public key pubkey from a ciphertext and a private key privkey, and may be a reverse process of Encap(pubkey).

According to an embodiment, in operation 1139, the server 1110 may encrypt encrypted credentials eCred and a second re-encrypted protection key eCeRk″ with a session key ssk shared with the client 1103.

According to an embodiment, the server 1110 may generate encrypted information eCek′ by encrypting the encrypted credentials eCred and the second re-encrypted protection key eCeRk″.

According to an embodiment, in operation 1139, the server 1110 may generate a shared key K_{C} with the client 1103 and a ciphertext c_{C} using a public key ek_{C} of the client 1103.

According to an embodiment, the server 1110 may generate qCek₂ by encrypting the encrypted information eCek′ using the shared key K_{C}. The ciphertext c_{C} may be qCek₁. Here, qCek, which may be second information in an encrypted form in the server 1110, may include qCek₁ and qCek₂. The encrypted information eCek′ may be referred to as first encrypted information. qCek, which may be information in which the first encrypted information is additionally encrypted, may be referred to as second encrypted information.

According to an embodiment, in operation 1141, the server 1110 may transmit the qCek to the client 1103.

According to an embodiment, in operation 1143, the client 1103 may obtain the shared key K_{C} between the client 1103 and the server 1110 by inputting the ciphertext c_{C} and a private key dk_{C} of the client 1103 to a Decap function.

According to an embodiment, in operation 1143, the client 1103 may decrypt qCek₂ using the shared key K_{C}. The client 1103 may obtain the encrypted information eCek′ by decrypting qCek₂.

According to an embodiment, in operation 1143, the client 1103 may generate a wrapping key wk by decrypting the encrypted information eCek′.

The method of generating the encrypted information eCek′ and the wrapping key wk is described above with reference to FIG. 6 and thus omitted herein.

Since operations 1145 and 1147 may be applied in the same manner as operations 645 and 647 of FIG. 6, the description of operations 1145 and 1147 is omitted.

Through operations 1131 to 1147, the electronic device may obtain the credentials. In other words, the credentials may be recovered. As the credentials are recovered, users may use the services they used on their previous electronic device on their current electronic device in the same manner.

In FIGS. 10 and 11, information may be safely protected against attacks using quantum computers by using encapsulation. In other words, the information may have quantum resistance.

According to an embodiment, an electronic device (e.g., the electronic device 101 of FIG. 1, the electronic device 200 of FIG. 2, and the first electronic device 900 of FIG. 9) may include a memory (e.g., the memory 130 of FIG. 1) storing instructions. The electronic device may include at least one processor (e.g., the processor 120 of FIG. 1) that executes instructions. When the at least one processor individually or collectively executes the instructions, the instructions may cause the electronic device to receive (e.g., obtain) lock release information of the electronic device from a user and generate authentication information and a wrapping key based on the lock release information. When the at least one processor individually or collectively executes the instructions, the instructions may cause the electronic device to generate a protection key and a recovery key for encrypting and decrypting the authentication information and credentials stored in the electronic device. When the at least the electronic device to encrypt the authentication information, the credentials, and the protection key based on keys of the electronic device, including the protection key and the recovery key. When the at least one processor individually or collectively executes the instructions, the instructions may cause the electronic device to transmit the encrypted credentials (e.g., the encrypted credentials 940 of FIG. 9), the encrypted authentication information, and the encrypted protection key to a server (e.g., the server 108 of FIG. 1, the server 210 of FIG. 2, the server 410 of FIG. 4, the server 610 of FIG. 6, the server 910 of FIG. 9, the server 1010 of FIG. 10, and the server 1110 of FIG. 11) performing an SRP protocol with the electronic device.

According to an embodiment, when the at least one processor individually or collectively executes the instructions, the instructions may cause the electronic device to generate the encrypted credentials by encrypting the credentials with the protection key. When the at least one processor individually or collectively executes the instructions, the instructions may cause the electronic device to generate an encrypted protection key by encrypting a multi-encrypted protection key and the recovery key based on a public key of a security device (e.g., the security device 220 of FIG. 2, the security device 420 of FIG. 4, the security device 620 of FIG. 6, the security device 1020 of FIG. 10, and the security device 1120 of FIG. 11) communicating with the server. When the at least one processor individually or collectively executes the instructions, the instructions may cause the electronic device to generate encrypted authentication information by encrypting the authentication information with the recovery key.

According to an embodiment, when the at least one processor individually or collectively executes the instructions, the instructions may cause the electronic device to generate the multi-encrypted protection key by encrypting the protection key with the recovery key and encrypting the protection key encrypted with the recovery key with the wrapping key.

According to an embodiment, the server may store the encrypted credentials, and transmit the encrypted protection key and the encrypted authentication information to the security device communicating with the server to re-encrypt the encrypted protection key and the encrypted authentication information.

According to an embodiment, the security device may obtain the multi-encrypted protection key and the recovery key by decrypting the protection key encrypted with the private key of the security device, and re-encrypt the recovery key and the multi-encrypted protection key with a symmetric key of the security device to generate a first re-encrypted protection key. The security device may transmit the first re-encrypted protection key to the server. The server may store the first re-encrypted protection key.

According to an embodiment, when another electronic device of the user is identified as a device of the user based on the SRP protocol, the encrypted credentials may be transmitted to the other electronic device.

According to an embodiment, the server may store the encrypted credentials based on lock release information of the other electronic device that is used to determine whether the other electronic device is the device of the user.

According to an embodiment, when the at least one processor individually or collectively executes the instructions, the instructions may cause the electronic device to, in response to receiving a command to recover the credentials, perform the SRP protocol with the server to share a session key. The command to recover the credentials may include the lock release information.

According to an embodiment, when the at least one processor individually or collectively executes the instructions, the instructions may cause the electronic device to receive encrypted information from the server. When the at least one processor individually or collectively executes the instructions, the instructions may cause the electronic device to decrypt the encrypted information based on the session key. When the at least one processor individually or collectively executes the instructions, the instructions may cause the electronic device to recover the credentials based on decrypted information based on the session key.

According to an embodiment, the electronic device may include a memory storing instructions. The electronic device may include at least one processor that executes instructions. When the at least one processor individually or collectively executes the instructions, the instructions may cause the electronic device to obtain lock release information used to store credentials from a user, and perform an SRP protocol with a server communicating with the electronic device to share a session key with the server. When the at least one processor individually or collectively executes the instructions, the instructions may cause the electronic device to receive from the server encrypted information in which encrypted credentials stored in the server and a second re-encrypted protection key are encrypted based on the session key. When the at least one processor individually or collectively executes the instructions, the instructions may cause the electronic device to obtain the encrypted credentials and the second re-encrypted protection key by decrypting the information with the session key. When the at least one processor individually or collectively executes the instructions, the instructions may cause the electronic device to generate a wrapping key based on the lock release information, and obtain the credentials by decrypting the second re-encrypted protection key and the encrypted credentials based on the wrapping key and keys stored in the electronic device.

According to an embodiment, the server may transmit the first re-encrypted protection key stored in the server to a security device. The security device may obtain a recovery key and a multi-encrypted protection key by decrypting the first re-encrypted protection key with a symmetric key of the security device. The security device may generate a second re-encrypted protection key by encrypting the recovery key and the multi-encrypted protection key with a public key of the electronic device.

According to an embodiment, when the at least one processor individually or collectively executes the instructions, the instructions may cause the electronic device to obtain the multi-encrypted protection key and the recovery key by decrypting the second re-encrypted protection key with a private key of the electronic device. When the at least one processor individually or collectively executes the instructions, the instructions may cause the electronic device to obtain the protection key by decrypting the multi-encrypted protection key with the wrapping key and the recovery key. When the at least one processor individually or collectively executes the instructions, the instructions may cause the electronic device to obtain the credentials by decrypting the encrypted credentials with the protection key.

According to an embodiment, the electronic device may include a memory storing instructions. The electronic device may include at least one processor that executes instructions. When the at least one processor individually or collectively executes the instructions, the instructions may cause the electronic device to receive lock release information of the electronic device from a user and generate authentication information and a wrapping key based on the lock release information. When the at least one processor individually or collectively executes the instructions, the instructions may cause the electronic device to generate a protection key and a recovery key for encrypting and decrypting authentication information and credentials stored in the electronic device. When the at least the electronic device to generate a password and a shared key with the server through key encapsulation based on a public key of the server. When the at least one processor individually or collectively executes the instructions, the instructions may cause the electronic device to generate encrypted authentication information, encrypted credentials and a first encrypted protection key by encrypting the authentication information, the credentials and the protection key based on the protection key and the recovery key. When the at least one processor individually or collectively executes the instructions, the instructions may cause the electronic device to generate a second encrypted protection key by additionally encrypting the first encrypted protection key based on the shared key and the password. When the at least one processor individually or collectively executes the instructions, the instructions may cause the electronic device to transmit the encrypted authentication information, the encrypted credentials, and the second encrypted protection key to the server.

According to an embodiment, the electronic device may include a memory storing instructions. The electronic device may include at least one processor that executes instructions. When the at least one processor individually or collectively executes the instructions, the instructions may cause the electronic device to obtain lock release information used to store credentials from a user, and perform an SRP protocol with a server communicating with the electronic device to share a session key with the server. When the at least one processor individually or collectively executes the instructions, the instructions may cause the electronic device to receive second encrypted information in which first encrypted information is additionally encrypted based on a shared key and a password generated based on a public key of a client of the electronic device. The first encrypted information may be encrypted information in which encrypted credentials and a second re-encrypted protection key are encrypted based on a session key. When the at least one processor individually or collectively executes the instructions, the instructions may cause the electronic device to obtain the first encrypted information based on the second encrypted information. When the at least one processor individually or collectively executes the instructions, the instructions may cause the electronic device to obtain the encrypted credentials and the second re-encrypted protection key by decrypting the first encrypted information with the session key. When the at least one processor individually or collectively executes the instructions, the instructions may cause the electronic device to generate a wrapping key based on the lock release information, and obtain the credentials by decrypting the second re-encrypted protection key and the encrypted credentials based on the wrapping key and keys stored in the electronic device.

According to an embodiment, an operating method of the electronic device may include receiving lock release information of the electronic device from a user. The operating method may include generating authentication information and a wrapping key based on the lock release information. The operating method may include generating a protection key and a recovery key for encrypting and decrypting authentication information and credentials stored in the electronic device. The operating method may include encrypting the authentication information, the credentials, and the protection key based on keys of the electronic device, including the protection key and the recovery key. The operating method may include transmitting the encrypted credentials, the encrypted authentication information, and the encrypted protection key to a server performing an SRP protocol with the electronic device.

According to an embodiment, the encrypting of the authentication information, the credentials, and the protection key may include generating encrypted credentials by encrypting the credentials with the protection key. The encrypting of the authentication information, the credentials, and the protection key may include generating the encrypted protection key by encrypting a multi-encrypted protection key and the recovery key based on a public key of a security device communicating with the server. The encrypting of the authentication information, the credentials, and the protection key may include generating the encrypted authentication information by encrypting the authentication information with the recovery key.

According to an embodiment, the encrypting of the authentication information, the credentials, and the protection key may include encrypting the protection key with the recovery key. The encrypting of the authentication information, the credentials, and the protection key may include generating the multi-encrypted protection key by encrypting the protection key encrypted with the recovery key with a wrapping key.

According to an embodiment, the server may store the encrypted credentials, and transmit the encrypted protection key and the encrypted authentication information to the security device communicating with the server to re-encrypt the encrypted protection key and the encrypted authentication information.

According to an embodiment, the security device may obtain the multi-encrypted protection key and the recovery key by decrypting the protection key encrypted with the private key of the security device, re-encrypt the recovery key and the multi-encrypted protection key with a symmetric key of the security device to generate a first re-encrypted protection key, and transmit the first re-encrypted protection key to the server. The server may store the first re-encrypted protection key.

According to an embodiment, when another electronic device of a user is identified as a device of the user based on the SRP protocol, the server may transmit the encrypted credentials to the other electronic device.

According to an embodiment, the server may store the encrypted credentials based on lock release information of the other electronic device that is used to determine whether the other electronic device is the device of the user.

According to an embodiment, a non-transitory computer-readable storage medium stores one or more computer programs, the one or more computer programs including instructions that, when individually and/or collectively executed by at least one processor, cause an electronic device to receive lock release information of the electronic device from a user, generate authentication information and a wrapping key based on the lock release information, generate a protection key and a recovery key for encrypting and decrypting authentication information and credentials stored in the electronic device, encrypt the authentication information, the credentials and the protection key based on keys of the electronic device including the protection key and the recovery key, and transmit the encrypted credentials, the encrypted authentication information, and the encrypted protection key to a server performing an SRP protocol with the electronic device.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine- readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

The embodiments of the present disclosure disclosed in the specification and the drawings are merely presented to easily describe technical contents of various embodiments of the present disclosure and help the understanding of them and are not intended to limit the various embodiments. Therefore, all changes or modifications derived from the technical idea of the various embodiments of the present disclosure as well as the various embodiments disclosed herein should be construed to fall within the various embodiments.

What is claimed is:

1. An electronic device comprising:
memory configured to store instructions; and
at least one processor configured to execute the instructions,
wherein the instructions, when executed by the at least one processor individually or collectively, cause the electronic device to:
obtain lock release information of the electronic device from a user,
generate, authentication information and a wrapping key based on the lock release information,
generate a protection key and a recovery key to encrypt and decrypt the authentication information and credentials stored in the electronic device,
encrypt the authentication information, the credentials, and the protection key based on keys of the electronic device, the keys including the protection key and the recovery key, and
transmit the encrypted credentials, the encrypted authentication information, and the encrypted protection key to a server performing a secure remote password (SRP) protocol with the electronic device.

2. The electronic device of claim 1, wherein the instructions, when executed by the at least one processor individually or collectively, cause the electronic device to:
generate the encrypted credentials by encrypting the credentials with the protection key,
generate the encrypted protection key by encrypting a multi-encrypted protection key and the recovery key based on a public key of a security device communicating with the server, and
generate the encrypted authentication information by encrypting the authentication information with the recovery key.

3. The electronic device of claim 2, wherein the instructions, when executed by the at least one processor individually or collectively, cause the electronic device to:
encrypt the protection key with the recovery key, and
generate the multi-encrypted protection key by encrypting the protection key encrypted with the recovery key with the wrapping key.

4. The electronic device of claim 2, wherein the server is configured to:
store the encrypted credentials, and
transmit the encrypted protection key and the encrypted authentication information to the security device communicating with the server to re-encrypt the encrypted protection key and the encrypted authentication information.

5. The electronic device of claim 2, wherein the security device is configured to:
obtain the multi-encrypted protection key and the recovery key by decrypting the encrypted protection key with a private key of the security device;
generate a first re-encrypted protection key by re-encrypting the recovery key and the multi-encrypted protection key with a symmetric key of the security device, and
transmit the first re-encrypted protection key to the server, and
wherein the server is configured to store the first re-encrypted protection key.

6. The electronic device of claim 1, wherein, based on another electronic device of the user being identified as a device of the user based on the SRP protocol, the server is configured to transmit the encrypted credentials to the another electronic device.

7. The electronic device of claim 6, wherein the server is configured to store the encrypted credentials based on lock release information of the another electronic device used to determine whether the another electronic device is the device of the user.

8. The electronic device of claim 1, wherein the instructions, when executed by the at least one processor individually or collectively, cause the electronic device to:
based on obtaining a command to recover the credentials, perform the SRP protocol with the server to share a session key, and
wherein the command to recover the credentials comprises the lock release information.

9. The electronic device of claim 8, wherein the instructions, when executed by the at least one processor individually or collectively, cause the electronic device to:
obtain encrypted information from the server,
decrypt the encrypted information based on the session key, and
recover the credentials based on the decrypted information based on the session key.

10. An electronic device comprising:
memory configured to store instructions; and
at least one processor configured to execute the instructions,
wherein the instructions, when executed by the at least one processor individually or collectively, cause the electronic device to:
based on obtaining lock release information used to store credentials from a user, perform a secure remote password (SRP) protocol with a server communicating with the electronic device to share a session key with the server,
obtain, from the server, encrypted information in which encrypted credentials stored in the server and a second re-encrypted protection key are encrypted based on the session key,
obtain the encrypted credentials and the second re-encrypted protection key by decrypting the encrypted information with the session key,
generate a wrapping key based on the lock release information, and
obtain the credentials by decrypting the second re-encrypted protection key and the encrypted credentials based on the wrapping key and keys stored in the electronic device.

11. The electronic device of claim 10, wherein the server is configured to transmit a first re-encrypted protection key stored in the server to a security device,
wherein the security device is configured to:
obtain a recovery key and a multi-encrypted protection key by decrypting the first re-encrypted protection key with a symmetric key of the security device, and
generate the second re-encrypted protection key by encrypting the recovery key and the multi-encrypted protection key with a public key of the electronic device.

12. The electronic device of claim 11, wherein the instructions, when executed by the at least one processor individually or collectively, cause the electronic device to:
obtain the multi-encrypted protection key and the recovery key by decrypting the second re-encrypted protection key with a private key of the electronic device,
obtain a protection key by decrypting the multi-encrypted protection key with the wrapping key and the recovery key, and
obtain the credentials by decrypting the encrypted credentials with the protection key.

13. An operating method of an electronic device, the operating method comprising:
obtaining lock release information of the electronic device from a user;
generating authentication information and a wrapping key based on the lock release information;
generating a protection key and a recovery key to encrypt and decrypt the authentication information and credentials stored in the electronic device;
encrypting the authentication information, the credentials, and the protection key based on keys of the electronic device, the keys including the protection key and the recovery key; and
transmitting the encrypted credentials, the encrypted authentication information, and the encrypted protection key to a server performing a secure remote password (SRP) protocol with the electronic device.

14. The operating method of claim 13, wherein the encrypting the authentication information, the credentials, and the protection key comprises:
generating the encrypted credentials by encrypting the credentials with the protection key;
generating the encrypted protection key by encrypting a multi-encrypted protection key and the recovery key based on a public key of a security device communicating with the server; and
generating the encrypted authentication information by encrypting the authentication information with the recovery key.

15. The operating method of claim 14, wherein the encrypting the authentication information, the credentials, and the protection key comprises:
encrypting the protection key with the recovery key; and
generating the multi-encrypted protection key by encrypting the protection key encrypted with the recovery key with the wrapping key.

16. The operating method of claim 14, further comprising, storing, using the server, the encrypted credentials, and transmitting the encrypted protection key and the encrypted authentication information to the security device communicating with the server to re-encrypt the encrypted protection key and the encrypted authentication information.

17. The operating method of claim 14, further comprising:
obtaining, using the security device, the multi-encrypted protection key and the recovery key by decrypting the encrypted protection key with a private key of the security device;
generating, using the security device, a first re-encrypted protection key by re-encrypting the recovery key and the multi-encrypted protection key with a symmetric key of the security device; and
transmitting, using the security device, the first re-encrypted protection key to the server,
wherein the server is configured to store the first re-encrypted protection key.

18. The operating method of claim 13, wherein based on another electronic device of the user being identified as a device of the user based on the SRP protocol, transmitting, using the server, the encrypted credentials to the another electronic device.

19. The operating method of claim 18, further comprising storing, using the server, the encrypted credentials based on lock release information of the another electronic device used to determine whether the another electronic device is a device of the user.

20. A non-transitory computer-readable storage medium storing instructions that, when executed by at least one processor, cause the at least one processor to perform the operating method of claim 13.
